(19) United States
(12) Patent Application Publication
(10) Pub. No.: US 2024/0179808 A1
(43) Pub. Date: May 30, 2024

(54) BLACK GLASS-CERAMIC TOP PLATE FOR COOKING APPARATUS AND INDUCTION HEATING DEVICE INCLUDING THE SAME

(71) Applicant: SAMSUNG ELECTRONICS CO., LTD., Suwon-si (KR)

(72) Inventors: Hyungin KIM, Suwon-si (KR); Jiyoung Song, Suwon-si (KR); Youngdeong Koh, Suwon-si (KR); Kwangjoo Kim, Suwon-si (KR)

(73) Assignee: SAMSUNG ELECTRONICS CO., LTD., Suwon-si (KR)

(21) Appl. No.: 18/373,705

(22) Filed: Sep. 27, 2023

Related U.S. Application Data
(63) Continuation of application No. PCT/KR2023/014342, filed on Sep. 21, 2023.

(30) Foreign Application Priority Data
Nov. 30, 2022 (KR) 10-2022-0165217
Apr. 7, 2023 (KR) 10-2023-0046349

(51) Int. Cl. H05B 6/10; C03C 17/00; C03C 21/00

(52) U.S. Cl. CPC H05B 6/105; C03C 17/002; C03C 21/002; C03C 2218/119

(57) ABSTRACT

A black glass-ceramic top plate for a cooking apparatus and an induction heating device including the same are provided. The black glass-ceramic top plate for a cooking apparatus includes: a black glass-ceramic substrate including a chemically strengthened upper surface; a shielding region provided with a printed layer disposed under the black glass-ceramic substrate to block light transmission; and a transmissive region not provided with the printed layer under the black glass-ceramic substrate to transmit light, wherein the printed layer includes: a background printed layer disposed under the black glass-ceramic substrate; and a shielding printed layer disposed under the background printed layer.

### CROSS-REFERENCE TO RELATED APPLICATIONS

This application is a Bypass Continuation Application of PCT Application No. PCT/KR2023/014342, filed in Korea on Sep. 21, 2023, which is based on and claims priority to Korean Patent Application No. 10-2022-0165217, filed on Nov. 30, 2022, and Korean Patent Application No. 10-2023-0046349, filed on Apr. 7, 2023, in the Korean Intellectual Property Office, the disclosures of which are incorporated by reference herein in their entireties.

### BACKGROUND

### 1. Field

The disclosure relates to a black glass-ceramic top plate, for a cooking apparatus realizing a clear black color and having excellent strength and scratch resistance, and an induction heating device including the black glass-ceramic top plate.

### 2. Description of Related Art

Induction heating devices are cooking apparatuses used to heat and cook food by using the principle of induction heating. An induction heating device includes a cooking apparatus top plate on which cooking vessels are placed and an induction coil configured to generate a magnetic field by a current applied thereto.

A magnetic field generated by a current supplied to a coil induces a secondary current in a cooking vessel, and thus Joule heat is generated by a resistance component of the cooking vessel. Therefore, the cooking vessel is heated by a high-frequency current and food contained in the cooking vessel is cooked.

While a thermal efficiency (for heating a cooking vessel) of a gas stove is about 45%, an induction heating device having a high thermal efficiency of about 90% may reduce cooking time.

In addition, because a cooking vessel itself is used as a heat source in an induction heating device, the induction heating device does not generate harmful gases, is safe with no risk of fire, and is easy to clean due to non-stick property, compared to gas stoves or kerosene cookers that heat a cooking vessel using heat obtained by burning fossil fuels, and thus the market for induction heating apparatuses has been recently expanding.

Although the top surface of induction heating devices is formed of a strengthened glass such as black glass-ceramic to prevent breakage of the top surface caused by frequent friction with a cooking vessel, scratches are formed in the case where a load is applied thereto at a high temperature. In addition, once scratches are formed, a contaminant is inserted into the scratches causing a problem in deteriorating cleanability and aesthetic property. Therefore, there is a need for a material for the top surface with improved scratch resistance as well as high strength.

### SUMMARY

Provided are a black glass-ceramic top plate for a cooking apparatus having a clear and pure black color compared to conventional black glass-ceramics with a brown color, and an induction heating device including the same.

Further, provided are a black glass-ceramic top plate for a cooking apparatus having excellent falling ball impact strength and scratch resistance, and an induction heating device including the same.

The technical problems to be addressed are not limited to the technical problems as described above, and thus other technical problems may be inferred by those of ordinary skill in the art based on the following descriptions.

According to an aspect of the disclosure, a black glass-ceramic top plate, for a cooking apparatus, includes: the black glass-ceramic top plate comprising a black glass-ceramic substrate including a chemically strengthened upper surface: a shielding region provided with a printed layer under the black glass-ceramic substrate to block light transmission; and a transmissive region not provided with the printed layer under the black glass-ceramic substrate to transmit light, wherein the printed layer is not included in the transmissive region, and wherein the printed layer comprises: a background printed layer under the black glass-ceramic substrate; and a shielding printed layer under the background printed layer.

The shielding region may include a chromaticity of L*: 20.0 to 21.5, a*: 0.1 to 0.3, and b*: 0.1 to 0.4.

The transmissive region may include a chromaticity of L*: 22.0 to 24.0, a*: 0.3 to 0.9, and b*: 0.4 to 1.0.

The black glass-ceramic substrate may include lithium aluminosilicate-based crystalline glass including Li₂O, Al₂O₃, and SiO₂.

The black glass-ceramic top plate may further include at least one element selected from V, Mg, P, Fe, Ti, and Zr.

The black glass-ceramic substrate may include at least one crystal phase selected from β-quartz, β-spodumene, and β-eucryptite crystal phases.

The upper surface of the black glass-ceramic substrate may be chemically strengthened by ion exchange with a strengthening salt of KNO3.

A chemical strengthening depth may be from 350 nm to 5.7 μm from the upper surface.

A Vickers hardness of the black-glass ceramic top plate may be from 950 to 1,300 Hv.

A falling ball breakage rate of the black glass-ceramic top plate may be 10% or less in a case of dropping a 535 g-steel ball from a height of 60 cm over the black glass-ceramic top plate.

According to an aspect of the disclosure, an induction heating device includes: a cooking apparatus top plate: and a plurality of induction heating coils under the cooking apparatus top plate and configured to generate a magnetic field, wherein the cooking apparatus top plate includes: a black glass-ceramic substrate including a chemically strengthened upper surface: a shielding region including a printed layer under the black glass-ceramic substrate; a transmissive region configured to transmit light: and an LED disposed under the transmissive region.

The printed layer may include a background printed layer, disposed under the black glass-ceramic substrate, and a shielding printed layer disposed under the background printed layer.

The shielding region may include a chromaticity of L*: 20.0 to 21.5, a*: 0.1 to 0.3, and b*: 0.1 to 0.4, and the transmissive region may include a chromaticity of L*: 22.0 to 24.0, a*: 0.3 to 0.9, and b*: 0.4 to 1.0.

The black glass-ceramic substrate may include lithium aluminosilicate-based crystalline glass comprising Li₂O, Al₂O₃, and SiO₂.

The black glass-ceramic substrate may further include at least one of V, Mg, P, Fe, Ti, and Zr.

The black glass-ceramic substrate may include at least one crystal phase of any of a β-quartz crystal phase, a β-spodumene crystal phase, and a β-eucryptite crystal phase.

### DESCRIPTION OF THE DRAWINGS

The above and other aspects, features, and advantages of certain embodiments of the present disclosure will be more apparent from the following description taken in conjunction with the accompanying drawings in which:

FIG. 1 is a cross-sectional view of a black glass-ceramic top plate for cooking apparatuses according to an embodiment:

FIG. 2 is a view illustrating an external appearance of an induction heating device according to an embodiment:

FIG. 3 is a view showing a state where a main body is separated from a cooking apparatus top plate in an induction heating device according to an embodiment:

FIG. 4 is an exploded perspective view illustrating a structure of a cooking apparatus top plate and an induction heating coil of an induction heating device according to an embodiment:

FIG. 5 shows comparison data of average height of falling ball causing breakage on a black glass-ceramic top plate before and after chemical strengthening:

FIG. 6 shows comparison data of falling ball breakage rates of a black glass-ceramic top plate before and after chemical strengthening:

FIG. 7 is a graph showing falling ball breakage rates with respect to chemical strengthening time:

FIG. 8 is a graph showing surface hardness with respect to chemical strengthening conditions:

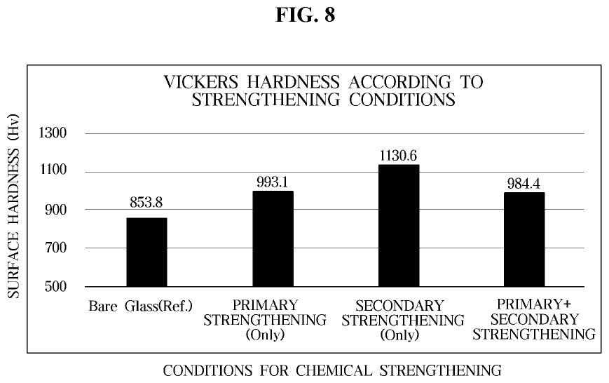

FIG. 9 is a graph showing surface hardness with respect to chemical strengthening time:

FIG. 10 shows surface K+ ion depth profile analysis results with respect to chemical strengthening time; and

FIG. 11 shows surface K+, Na+, and Li+ ion depth profile analysis results in the case of chemical strengthening for 8 hours.

### DETAILED DESCRIPTION

Hereinafter, example embodiments of the present disclosure will be described with reference to the appended drawings. However, various embodiments and terms used herein should not be construed as limited to these example embodiments of the present disclosure set forth herein. It should be understood that there is no intent to limit the disclosure to the particular forms disclosed, but on the contrary, the disclosure is to cover all modifications, equivalents, and alternatives falling within the spirit and scope of the disclosure.

Like reference numerals refer to like elements throughout the description of the drawings.

An expression used in the singular encompasses the expression of the plural, unless otherwise indicated.

As used herein, the expressions “A or B”, “at least one of A and B”, “at least one of A or B”, “A, B, or C”, “at least one of A, B, and C”, and “at least one of A, B, or C” may include A alone, B alone, C alone, or any combinations thereof.

The term “and/or” includes a combination of a plurality of associated listed elements or one element among the plurality of associated listed elements.

The terms “first”, “second”, or the like may be used herein to simply distinguish one element from another and do not limit the elements in another aspect (e.g., importance or order).

In addition, the terms used throughout the specification, ‘front surface’, ‘rear surface’, ‘upper surface’, ‘lower surface’, ‘side surface’, ‘left’, ‘right’, ‘top’, ‘bottom’ and the like are defined based on the drawings and the shape and position of each element are not limited by these terms.

As used herein, it is to be understood that the terms such as “include”, “have”, or the like, are intended to indicate the existence of the features, numbers, operations, components, parts, and any combination thereof disclosed in the specification, and are not intended to preclude the possibility that one or more other features, numbers, operations, components, parts, and any combination thereof may exist or may be added.

When an element is referred to as being “connected to”, “coupled to”, “supported by”, or “in contact with” another element, it may be directly connected to, coupled to, supported by, or in contact with the other element or indirectly connected to, coupled to, supported by, or in contact with the other element via a third element.

It will also be understood that when an element is referred to as being “on” another element, it can be directly on the other element, or intervening elements may also be present therebetween.

The terms “about”, “substantially”, etc. used throughout the specification means that when a natural manufacturing and a substance allowable error are suggested, such an allowable error corresponds the value or is similar to the value, and such values are intended for the sake of clear understanding of the present disclosure or to prevent an unconscious infringer from illegally using the disclosure of the present disclosure.

Hereinafter, a black glass-ceramic top plate for a cooking apparatus and an induction heating device including the same according to various embodiments will be described in detail with reference to the accompanying drawings.

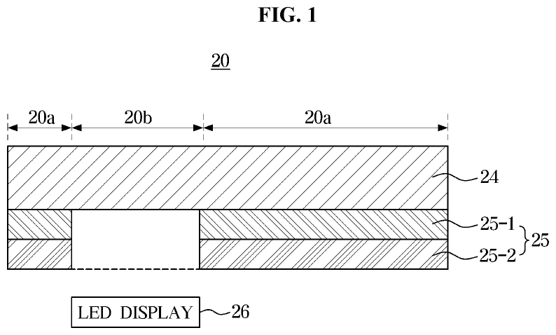

FIG. 1 is a cross-sectional view of a black glass-ceramic top plate 20 for a cooking apparatus according to an embodiment.

As shown in FIG. 1, a black glass-ceramic top plate 20 for cooking apparatuses includes a black glass-ceramic substrate 24 including a chemically strengthened upper surface.

In the black glass-ceramic substrate 24, lithium aluminosilicate-based crystalline glass including Li₂O, Al₂O₃, and SiO₂ as a basic composition may be used for heat resistance property. In addition, the black glass-ceramic substrate 24 may further include at least one element selected from V, Mg, P, Fe, Ti, Cr, and Zr according to a color to be realized, without being limited thereto. More specifically, the color may vary according to contents of elements contained in the black glass-ceramic substrate 24, and the V content may be increased to realize black color.

In addition, the black glass-ceramic substrate 24 may include at least one crystal phase selected from β-quartz, β-spodumene, and β-eucryptite crystal phases. The crystal phase of the black glass-ceramic substrate 24 varies according to crystallization temperature, and the color of the black glass-ceramic substrate 24 may vary according to the crystal phase. For example, the black glass-ceramic substrate 24 may include at least one crystal phase selected from β-quartz, β-spodumene, and β-eucryptite crystal phases.

To increase surface hardness and strength, the surface of the black glass-ceramic substrate 24 is chemically strengthened. Chemical strengthening may be performed, for example, by using KNO₃ as a strengthening salt. Specifically, the chemical strengthening may be performed by ion exchange between lithium ions (Li+) contained in the black glass-ceramic substrate 24 and cations (K+) of the strengthening salt.

In the chemically strengthened black glass-ceramic substrate 24, a chemical strengthening depth may be from 350 nm to 5.7 μm from the surface of the black glass-ceramic substrate 24. In this regard, the chemical strengthening depth refers to a depth in which cations (K+) are saturated in the surface of the substrate by ion exchange after the chemical strengthening. With a chemical strengthening depth below the lower limit, effects on improving surface hardness and falling ball impact strength cannot be achieved simultaneously. With a chemical strengthening depth above the upper limit, process efficiency may be reduced.

According to an embodiment, the chemical strengthening may be performed on the black glass-ceramic substrate 24 by using KNO₃ having a concentration of 90 to 100 wt %, as a strengthening salt, for 7 hours or more, or for 8 hours or more. By performing the chemical strengthening for over 7 hours, the chemical strengthening depth may be 5 μm or more, thereby simultaneously obtaining excellent surface hardness and falling ball impact strength. Although the surface hardness may be improved even by chemical strengthening of a short period of time, chemical strengthening depth is not sufficient by a chemical strengthening time less than 7 hours so that a falling ball breakage rate exceeds 10%, and thus chemical strengthening may be performed for 7 hours or more.

Because friction continuously occurs on the top surface of the black glass-ceramic top plate 20 for cooking apparatuses, surface hardness and strength are required to be increased to improve impact strength and reduce scratches of the surface. The black glass-ceramic top plate 20 for cooking apparatuses may have a Vickers hardness of, for example, 950 Hv, or 950 to 1,300 Hv, or 1,000 to 1,300 Hv. The hardness satisfying the range described above may be considered as a sufficient surface hardness.

In addition, the black glass-ceramic top plate 20 for cooking apparatuses may have a falling ball breakage rate of about 10% or less, preferably, 0% in the case of dropping a 535 g-steel ball from a height of 60 cm. More specifically, in the case of dropping the 535 g-steel ball, a height of the falling ball causing breakage on the black glass-ceramic top plate for a cooking apparatus may be greater than about 60 cm, or about 70 cm or more.

Meanwhile, referring to FIG. 1, a printed layer 25 is provided under the black glass-ceramic substrate 24 to realize the desired black color and prevent the inner structure of an induction range from being visible from the outside.

The printed layer 25 may include a polyester-based polymer material as a base material and further include titanium oxide (TiO₂), silicon oxide (SiO₂), glass beads, Si, Cr, Mg, and the like in accordance with a desired color to be realized. A large amount of an inorganic material and a metallic pigment may be added to obtain heat resistance of ink. In addition, cyclohexane, trimethyl benzene, methyl methacrylate, and the like may be used as a solvent and hardening agent, without being limited thereto.

In addition, the black glass-ceramic top plate 20 may have a shielding region 20a provided with a printed layer 25 disposed under the black glass-ceramic substrate 24 to block light transmission, and a transmissive region 20b not provided with the printed layer under the black glass-ceramic substrate 24 to transmit light.

The shielding region 20a does not transmit light due to the printed layer 25 formed thereunder, and thus a clear and pure black color may be realized. In this regard, the clear and pure black color may refer to a color having a chromaticity of L*: 20.0 to 21.5, a*: 0.1 to 0.3, and b*: 0.1 to 0.4. Herein, the chromaticity is described as in a CIELAB color space of which L* is s lightness value, a* is value on an axis of green-magenta opponent colors, and b* is a value on an axis of blue-yellow opponent colors.

The transmissive region 20b transmits light because the printed layer is not formed thereunder and thus have a brownish color having, for example, a chromaticity of L*: 22.0 to 24.0, a*: 0.3 to 0.9, and b*: 0.4 to 1.0. In addition, a light-emitting diode (LED) display 26 may be disposed under the transmissive region 20b. The printed layer is not formed to obtain transmittance of the transmissive region 20b, and therefore visibility of the LED display 26 may be obtained.

According to an embodiment, the printed layer 25 includes a background printed layer 25-1. For example, the background printed layer 25-1 may be provided under the black glass-ceramic substrate 24 to differentiate the design by realizing a color visible from the outside or to display a guide mark to guide a user to a position for heating a cooking vessel.

In another embodiment, a guide mark to guide a user to a position for heating a cooking vessel may be separately formed on the black glass-ceramic substrate 24 by glass printing. The glass printing is conducted by applying a design with a glass-printing ink to a glass-ceramic and heating the design at a preset temperature such that the ink permeates into the black glass-ceramic. Any materials known as an ink for glass printing of black glass-ceramics may be used without limitation.

According to an embodiment, the printed layer 25 includes a shielding printed layer 25-2. For example, the shielding printed layer 25-2 may be disposed under the background printed layer 25-1 to prevent the inner structure of the device from being visible to a user.

According to an embodiment, an antifouling layer may further be formed on the black glass-ceramic substrate 24 to improve cleanability and antifouling property of a cooking apparatus top plate 20. The antifouling layer may include, for example, an inorganic material such as zirconium oxide (ZrO₂) and titanium oxide (TiO₂) to improve surface slipperiness and heat resistance, but embodiments are not limited thereto.

In addition, the antifouling layer may include an anti-finger printing (AF) coating layer. For example, the anti-finger printing coating layer may have a structure in which perfluoro polyether (PFPE) binds to a silane base used as a coupling agent and may further include an inorganic material for improving heat resistance, such as zirconium oxide (ZrO₂) and titanium oxide (TiO₂).

According to an embodiment, the above-described black glass-ceramic top plate 20 for cooking apparatuses may be used as a top plate of an induction heating device 1.

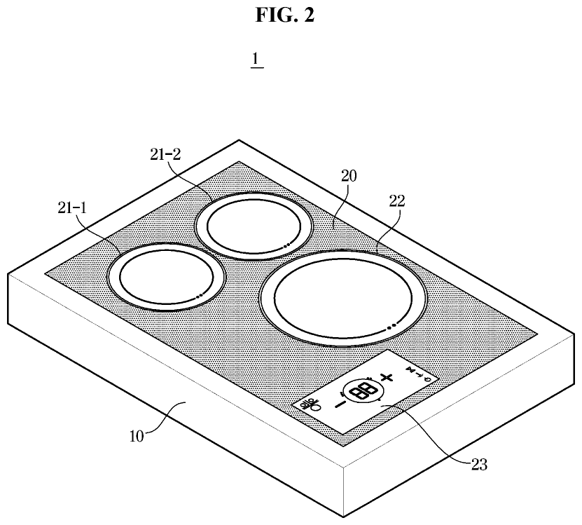

FIG. 2 is a view illustrating an external appearance of an induction heating device 1 according to an embodiment of the present disclosure.

Referring to FIG. 2, the induction heating device 1 includes a main body 10 constituting an external appearance of the induction heating device 1 and used to mount various components of the induction heating device 1. The main body 10 may be provided in a box shape with an open top.

The cooking apparatus top plate 20 having a flat-panel shape on which a cooking vessel is to be placed may be provided on the top surface of the main body 10.

If heat-resistant glass having a lower coefficient of thermal expansion than ordinary glass were used as a material for the top plate of an induction heating device, i.e., the cooking apparatus top plate 20, there would be limits to designing of a pattern of transparent heat-resistant glass due to a low degree of freedom in exterior patterns.

A material applied to the top plate of an induction heating device should have a low coefficient of thermal expansion for protection against thermal impact. In the present disclosure, a black glass-ceramic is used as a substrate to maintain heat resistance required for induction heating devices.

Hereinafter, the black glass-ceramic substrate 24 and the printed layer 25 of the cooking apparatus top plate 20 will be described.

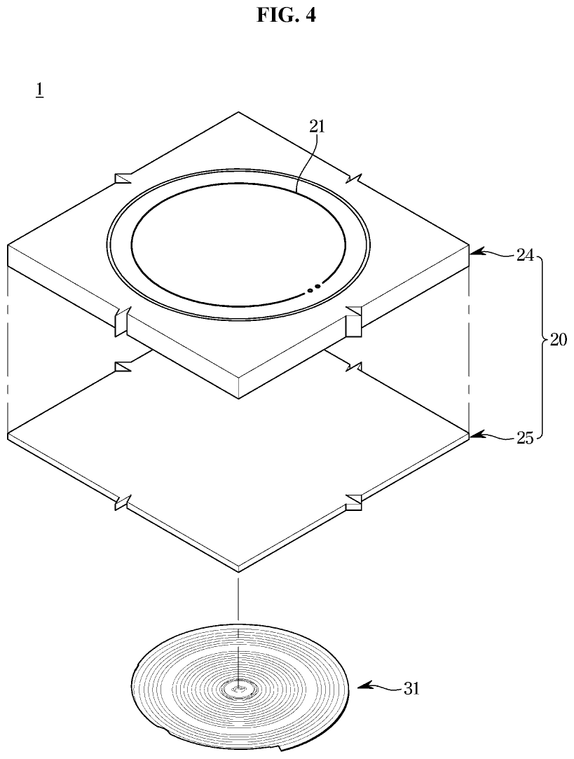

FIG. 4 is an exploded perspective view illustrating a structure of a cooking apparatus top plate and an induction heating coil of an induction heating device according to an embodiment of the present disclosure. Referring to FIG. 4, the printed layer 25 may be coupled to the bottom surface of the black glass-ceramic substrate 24.

The black glass-ceramic substrate 24 may have a flat-panel shape to allow a cooking vessel to be placed thereon and may be formed of a material with a low coefficient of thermal expansion. For example, the black glass-ceramic substrate 24 may be formed of a material satisfying heat resistance conditions required as a material of a cooking apparatus top plate of an induction heating device.

The black glass-ceramic substrate 24 includes a chemically strengthened top surface. Detailed descriptions of the black glass-ceramic substrate 24 are identical to those given above with respect to the black glass-ceramic top plate for a cooking apparatus and thus will not be repeated.

Referring to FIG. 1, the cooking apparatus top plate 20 according to an embodiment includes a shielding region 20a provided with a printed layer 25 under the black glass-ceramic substrate 24 and a transmissive region 20b not provided with the printed layer 25 under the black glass-ceramic substrate 24.

Because light is not transmitted by the shielding region 20a due to the printed layer 25 disposed under the black glass-ceramic substrate 24, the shielding region 20a may realize a clear and pure black color. In this regard, the clear and pure black color may refer to a color having a chromaticity of L*: 20.0 to 21.5, a*: 0.1 to 0.3, and b*: 0.1 to 0.4. In addition, the transmissive region 20b transmits light because the printed layer is not formed under the black glass-ceramic substrate 24, and the transmissive region 20b may have a color having a chromaticity of L*: 22.0 to 24.0, a*: 0.3 to 0.9, and b*: 0.4 to 1.0, and the LED display 26 may be disposed thereunder. The transmissive region 20b may obtain visibility of the LED display 26 by not forming the printed layer to obtain transmittance.

In addition, according to an embodiment, the printed layer 25 may include the background printed layer 25-1 disposed under the black glass-ceramic substrate 24 to differentiate a design by realizing a color visible from the outside or to display a guide mark to guide a user to a position for heating a cooking vessel. In addition, the shielding printed layer 25-2 may further be disposed under the background printed layer 25-1 to prevent the internal structure of the apparatus from being visible to the user. Descriptions of the printed layer 25 are identical to those given above with respect to the black glass-ceramic top plate and will not be repeated.

According to another embodiment, guide mark 21-1, guide mark 21-2, and guide mark 22 are provided to guide the user to positions for heating cooking vessels may be additionally formed on the black glass-ceramic substrate 24. In this regard, the guide mark 21-1, the guide mark 21-2, and the guide mark 22 may be formed by glass printing performed by applying a glass-printing ink to the surface of the black glass-ceramic substrate 24 in a pattern and heating the pattern at a preset temperature such that the ink permeates into the black glass-ceramic. In addition, any material known as an ink for glass printing may be used in the glass printing, without limitation.

According to an embodiment, an antifouling layer may further be formed on the black glass-ceramic substrate 24. For example, the antifouling layer may be formed on the glass-printed black glass-ceramic substrate 24. In the case where the antifouling layer is formed on the black glass-ceramic substrate 24, cleanability and antifouling property of the cooking apparatus top plate 20 may be improved. For example, the antifouling layer may include an inorganic material such as zirconium oxide (ZrO₂) and titanium oxide (TiO₂) to improve surface slipperiness and heat resistance, but is not limited thereto.

In addition, the antifouling layer may include an anti-finger printing (AF) coating layer. For example, the anti-finger printing coating layer may have a structure in which perfluoro polyether binds to a silane base used as a coupling agent, and may further include an inorganic material such as zirconium oxide (ZrO₂) and titanium oxide (TiO₂) to improve heat resistance.

Hereinafter, three guide marks will be described, but the number of the guide marks is not limited thereto, and two or more guide marks may be included without limitation.

In addition, a user interface 23 may be provided on a region of the cooking apparatus top plate 20 corresponding to the transmissive region 20b and may be configured to receive a control command from a user and display information on an operation of the induction heating device 1 to the user. However, the position of the user interface 23 is not limited to the cooking apparatus top plate 20 and the user interface 23 may also be provided at various positions, such as a front surface and/or a side surface, of the main body 10.

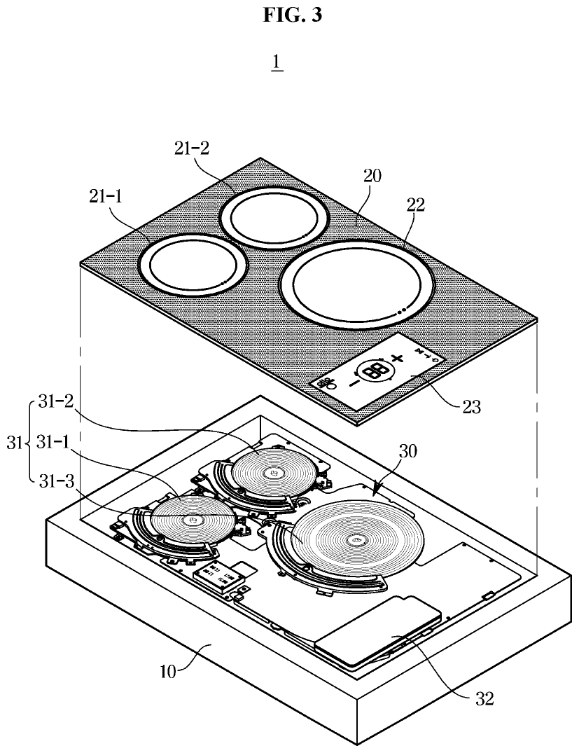

FIG. 3 is a view showing a state where a main body of an induction heating device is separated from a cooking apparatus top plate according to an embodiment of the present disclosure.

Referring to FIG. 3, the induction heating device 1 includes a heating layer 30 disposed under the cooking apparatus top plate 20 and including a plurality of induction heating coils 31 (one first induction heating coil 31-1, another first induction heating coil 31-2, and a second induction heating coil 31-3), configured to heat cooking vessels placed on the cooking apparatus top plate 20 and a main assembly 32 configured to implement the user interface 23 and accommodates various electronic components, for example, the LED display.

The plurality of induction heating coils 31 are heated by electromagnetic induction to heat cooking vessels placed on the cooking apparatus top plate 20.

The induction heating coils 31 include a coil wound in a substantially circular shape to generate a magnetic field in a vertical direction by a current applied thereto. The induction heating coils 31 are used as a heat source and disposed under the cooking apparatus top plate 20 to transfer heat to the cooking apparatus top plate 20. A cooking vessel such as a pot is heated by heat transferred to the cooking apparatus top plate 20. Although the induction heating coils 31 are described as a heat source in the present disclosure, an induction heater using an induction heating method or a radiant heater using an electrical resistance method may also be used as a heat source instead of the induction heating coils 31.

In this case, the plurality of induction heating coils 31 may be provided at positions corresponding to the guide mark 21-1, the guide mark 21-2, and the guide mark 22, respectively.

Specifically, the plurality of induction heating coils 31 may include one first induction heating coil 31-1, the other first induction heating coil 31-2, and a second induction heating coil 31-3.

Although FIG. 3 illustrates the one first induction heating coil 31-1, the other first induction heating coil 31-2, and one second induction heating coil 31-3, embodiments are not limited thereto. The induction heating device 1 may include at least one first induction heating coil 31-1 and at least one second induction heating coil 31-3.

That is, the numbers of the one first induction heating coil 31-1 and the other first induction heating coil 31-2 and the second induction heating coil 31-3 contained in the induction heating device 1 are not limited and may include one or more thereof.

Each of the plurality of induction heating coils 31 may generate a magnetic field and/or electromagnetic field for heating a cooking vessel.

For example, a driving current supplied to the induction heating coil 31 may induce a magnetic field around the induction heating coil 31.

Particularly, a current that changes magnitude and reverses direction over time, i.e., alternating current, supplied to the induction heating coil 31, may induce a magnetic field whose magnitude and direction vary over time around the induction heating coil 31.

A magnetic field generated around the induction heating coil 31 may pass through the cooking apparatus top plate 20 formed of a strengthened glass and arrive at a cooking vessel placed on the cooking apparatus top plate 20.

An eddy current circulating along a magnetic field may be generated in the cooking vessel by the magnetic field whose magnitude and direction change over time. A phenomenon in which an eddy current is generated by a time-varying magnetic field is referred to as electromagnetic induction. Electrical resistance heat may be generated in the cooking vessel by eddy current. Electrical resistance heat is heat generated in a resistor while a current flows in the resistor and is also called Joule heat. The cooking vessel is heated by such electrical resistance heat and an object to be cooked contained in the cooking vessel C may be heated.

As described above, each of the plurality of induction heating coils 31 may heat the cooking vessel by using electromagnetic induction and electrical resistance heat.

Also, the heating layer 30 may be disposed under the user interface 23 provided at one region of the cooking apparatus top plate 20 and include the main assembly 32 configured to implement the user interface 23.

The main assembly 32 may be a printed board assembly (PBA) including a display, a switching element, and an integrated circuit element for implementing the user interface 23 and a printed circuit board (PCB) mounted with these elements.

The position of the main assembly 32 is not limited to that shown in FIG. 3 and the main assembly 32 may be disposed at various positions. For example, in the case where the user interface 23 is mounted on the front surface of the main body 10, the main assembly 32 may be disposed behind the front surface separately from the heating layer 30.

A PCB assembly configured to operate the plurality of induction heating coils 31 may be provided under the plurality of induction heating coils 31. The plurality of PCB assemblies may be provided with a driving circuit configured to supply a driving current to the plurality of induction heating coils 31 and a control circuit configured to control the operations of the plurality of induction heating coils 31.

As described above, the induction heating device 1 may include the cooking apparatus top plate 20 having a flat-panel shape on which cooking vessels are placed, a plurality of induction heating coils 31 configured to heat the cooking vessels, and a driving circuit and a control circuit configured to operate the plurality of induction heating coils 31.

The above-described induction heating device is merely an example of a device according to an embodiment. That is, the above-described black glass-ceramic substrate may also be applied to the exterior of various types of apparatuses well known in the art without limitation as well as the above-described induction heating device. Therefore, any devices including the above-described black glass-ceramic substrate as an exterior material may be used as an example of the present disclosure.

The black glass-ceramic top plate 20 for cooking apparatuses according to an embodiment includes a black glass-ceramic substrate 24 including a chemically strengthened upper surface: a shielding region 20a provided with a printed layer 25 disposed under the black glass-ceramic substrate 24 to block light transmission; and a transmissive region 20b not provided with the printed layer under the black glass-ceramic substrate to transmit light. The printed layer 25 may include a background printed layer 25-1 disposed under the black glass-ceramic substrate; and a shielding printed layer 25-2 disposed under the background printed layer 25-1.

In addition, the shielding region 20a may have a chromaticity of L*: 20.0 to 21.5, a*: 0.1 to 0.3, and b*: 0.1 to 0.4.

In addition, the transmissive region 20b may have a chromaticity of L*: 22.0 to 24.0, a*: 0.3 to 0.9, and b*: 0.4 to 1.0.

In addition, the black glass-ceramic substrate may include lithium aluminosilicate-based crystalline glass including Li₂O, Al₂O₃, and SiO₂ as a basic composition.

In addition, the black glass-ceramic substrate may further include at least one element selected from V, Mg, P, Fe, Ti, and Zr.

In addition, the black glass-ceramic substrate may include at least one crystal phase selected from β-quartz, β-spodumene, and β-eucryptite crystal phases.

In addition, the surface of the black glass-ceramic substrate may be chemically strengthened by ion exchange with KNO₃ that is a strengthening salt.

In addition, a chemical strengthening depth may be from 350 nm to 5.7 μm from the surface of the black glass-ceramic substrate 24.

In addition, the surface of the black glass-ceramic top plate 20 may have a Vickers hardness of 950 to 1,300 Hv.

In addition, the black glass-ceramic top plate 20 may have a falling ball breakage rate of 10% or less in the case of dropping a 535 g-steel ball from a height of 60 cm.

An induction heating device 1 according to an embodiment includes: a cooking apparatus top plate 20 on which cooking vessels are placed; and a plurality of induction heating coils 31 disposed under the cooking apparatus top plate and configured to generate magnetic fields. The cooking apparatus top plate 20 includes a black glass-ceramic substrate 24 including a chemically strengthened upper surface: a shielding region 20a provided with a printed layer 25 disposed under the black glass-ceramic substrate 24; a transmissive region 20b not provided with the printed layer under the glass-ceramic substrate; and an LED disposed under the transmissive region.

In addition, the printed layer 25 may include: a background printed layer 25-1 disposed under the black glass-ceramic substrate 24; and a shielding printed layer 25-2 disposed under the background printed layer 25-1.

In addition, the shielding region 20a may have a chromaticity of L*: 20.0 to 21.5, a*: 0.1 to 0.3, and b*: 0.1 to 0.4. The transmissive region 20b may have a chromaticity of L*: 22.0 to 24.0, a*: 0.3 to 0.9, and b*: 0.4 to 1.0.

In addition, the black glass-ceramic substrate 24 may include lithium aluminosilicate-based crystalline glass including Li₂O, Al₂O₃, and SiO₂ as a basic composition. Optionally, the black glass-ceramic substrate 24 may further include at least one element selected from V, Mg, P, Fe, Ti, and Zr.

In addition, the black glass-ceramic substrate 24 may include at least one crystal phase selected from β-quartz, β-spodumene, and β-eucryptite crystal phases.

In addition, the black glass-ceramic substrate 24 may have a chemical strengthening depth of 350 nm to 5.7 μm from the surface.

In addition, the cooking apparatus top plate 20 may have a Vickers hardness of 950 to 1,300 Hv.

According to an aspect of the present disclosure, a black glass-ceramic top plate for a cooking apparatus realizing a clear black color, and an induction heating device including the same may be provided.

According to an aspect of the present disclosure, a black glass-ceramic top plate for a cooking apparatus having excellent falling ball impact strength and excellent scratch resistance, and an induction heating device including the same may be provided.

According to an aspect of the present disclosure, visibility of the LED display may be obtained by using a printed layer-free structure in an LED display region.

However, the effects obtainable by the present disclosure are not limited to the aforementioned effects, and any other effects not mentioned herein will be clearly understood from the following description by those skilled in the art to which the present disclosure pertains.

Hereinafter, the present disclosure will be described in more detail with reference to the following examples. However, the following examples are merely presented to describe the present disclosure in more detail, and the scope of the present disclosure are not limited thereto.

### EXAMPLES

### Experimental Example 1: Comparison of Falling Ball Impact Strength According to Chemical Strengthening

Lithium aluminosilicate having a β-quartz crystal phase was used as a black glass-ceramic substrate and the black glass-ceramic substrate was chemically strengthened in a 100 wt % KNO₃ solution at 380° ° C. for 8 hours to prepare a chemically strengthened substrate.

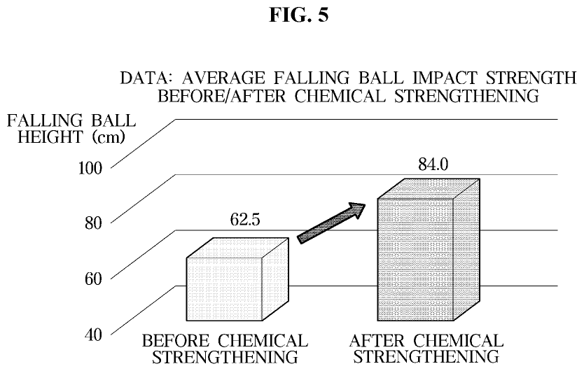

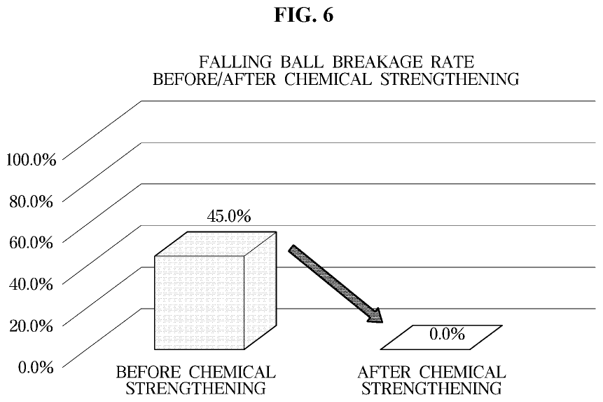

A falling ball experiment was conducted on the substrate using a 535 g-steel ball before and after the chemical strengthening, and an average height causing breakage on the substrate and breakage caused by the falling ball from a falling height of 60 cm were measured 20 times, respectively. Average falling heights and falling ball breakage rates are shown in FIG. 5 and FIG. 6. The falling height was measured up to 90 cm. In the case where the substrate was not broken from the falling height up to 90 cm, an average was calculated with the falling height of 90 cm.

As shown in FIG. 5 and FIG. 6, the average falling height of the substrate was 62.5 cm before the chemical strengthening, and a breakage rate from the falling height 60 cm was 45.0%. On the contrary, the falling height significantly increased to 84.0 cm after the chemical strengthening, and the breakage rate from the falling height of 60 cm was 0%. It was confirmed that no breakage occurred from a falling height of 60 cm or below.

That is, it was confirmed that falling ball impact strength of the black glass-ceramic substrate was significantly increased by chemical strengthening.

### Experimental Example 2: Comparison of Falling Ball Impact Strength According to Chemical Strengthening Time

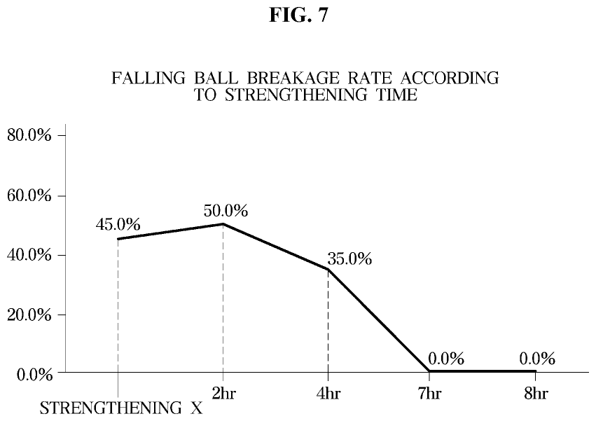

For comparison of falling ball impact strength according to chemical strengthening time, a lithium aluminosilicate substrate having a β-quartz crystal phase was chemically strengthened in a 100 wt % KNO₃ solution for various chemical strengthening time, and falling ball breakage from a falling height of 60 cm was measured 20 times, and falling ball breakage rates were calculated. The results are shown in Table 1 and FIG. 7.

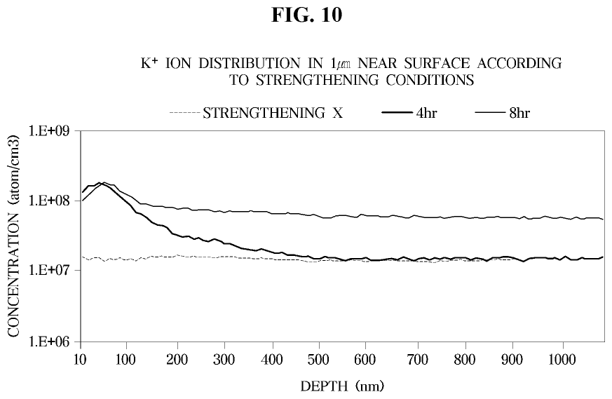

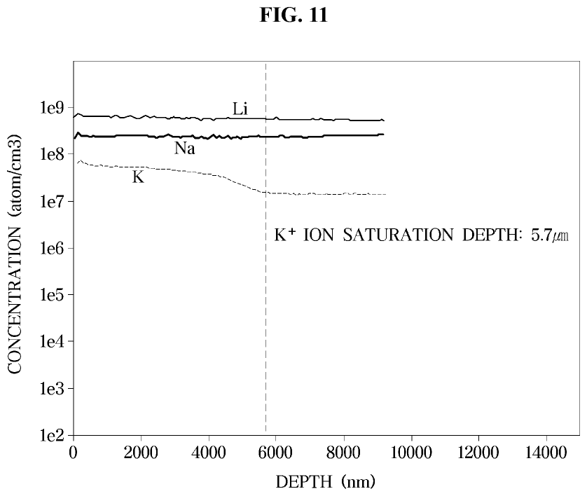

In addition, chemical strengthening depths with respect to chemical strengthening time were identified by ion depth profile analysis (FIG. 10 and FIG. 11).

TABLE 1

| Chemical strengthening | Chemical strengthening | Falling ball |
|---|---|---|
| time | depth | breakage rate |
| — | — | 45.0% |
| 2 hours | 350 nm | 50.0% |
| 4 hours | 500 nm | 35.0% |
| 7 hours | 3.0 μm | 0.0% |
| 8 hours | 5.7 μm | 0.0% |

Referring to Table 1 and FIG. 7, as the chemical strengthening time tends to increase, the chemical strengthening depth (K+ ion saturation depth) tends to increase and the falling ball breakage rate decreased. In addition, in the case where the chemical strengthening was performed for 7 hours or more, it was confirmed that breakage did not occur by the ball falling from the falling height of 60 cm. Specifically, FIG. 10 shows analysis results of surface K+ ion depth profile up to 1 μm, and it was confirmed that a larger amount of K+ ions was substituted to a deeper position by the chemical strengthening performed for 8 hours compared to the chemical strengthening performed for 4 hours. In addition, FIG. 11 shows surface K+, Na+, and Li+ ion depth profile analysis results in the case of chemical strengthening performed for 8 hours, and it was confirmed that the K+ ion saturation depth increased to 5.7 μm.

### Experimental Example 3: Comparison of Hardness According to Conditions for Chemical Strengthening

For comparison of surface hardness according to strengthening conditions, a lithium aluminosilicate substrate having a β-quartz crystal phase was chemically strengthened according to methods shown in Condition 1, Condition 2, and Condition 3 below.
1) Condition 1 (Primary Strengthening): The substrate was chemically strengthened in a mixed solution of NaNO₃ and KNO₃ (weight ratio of 64:36) at 400° ° C. for 3 hours.
2) Condition 2 (Secondary Strengthening): The substrate was chemically strengthened in a 100 wt % KNO₃ solution at 380° ° C. for 20 minutes.
3) Condition 3 (Primary+Secondary Strengthening): The substrate was chemically strengthened under Condition 1 above and then chemically strengthened under Condition 2 above.

Vickers hardness was measured on the glass-ceramic substrate before chemical strengthening and the substrates chemically strengthened according to the methods of Conditions 1 to 3, and the results are shown in FIG. 10.

Referring to FIG. 10, it was confirmed that the highest surface hardness of 1,000 Hv or more was obtained under Condition 2 in which chemical strengthening was performed with a high-concentration KNO₃ solution.

### Experimental Example 4: Comparison of Surface Hardness According to Chemical Strengthening Time

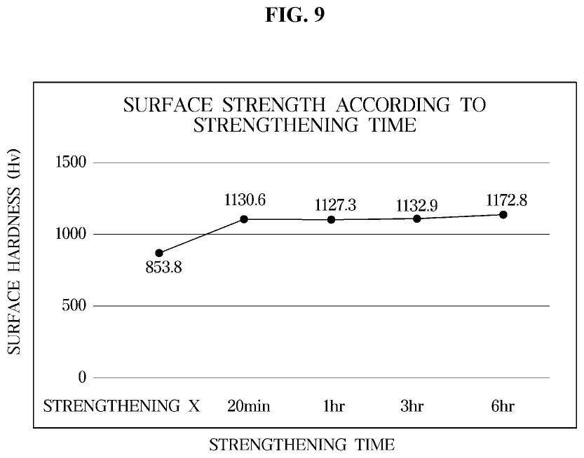

For comparison of surface hardness according to chemical strengthening time, a lithium aluminosilicate substrate having a β-quartz crystal phase was chemically strengthened with a 100 wt % KNO₃ solution for various chemical strengthening time, and then Vickers hardness thereof was measured. The results are shown in FIG. 9.

Referring to FIG. 9, although the chemical strengthening time increased, no significant difference was observed compared to the chemical strengthening performed for 20 minutes. However, as confirmed in Experimental Example 2 above, in order to obtain both excellent surface hardness and high falling ball impact strength, a chemical strengthening depth greater than a certain level needs to be obtained by performing chemical strengthening over 7 hours.

### Experimental Example 5: Comparison of Color According to Printed Layer

In order to identify realization of pure black by forming a printed layer, three areas were randomly selected from the shielding regions of Example 1, Example 2, and Example 3 in which the printed layer was disposed under the black glass-ceramic substrate, and three areas were randomly selected from the transmissive regions of Comparative Examples 1 to 3 in which the printed layer was not disposed. Color coordinates of the areas were measured and shown in Table 2.

TABLE 2

| | L* | a* | b* |
|---|---|---|---|
| Example 1 | 20.0 | 0.1 | 0.1 |
| Example 2 | 21.5 | 0.2 | 0.15 |
| Example 3 | 20.8 | 0.3 | 0.4 |
| Comparative Example 1 | 23.1 | 0.3 | 0.4 |
| Comparative Example 2 | 22.0 | 0.57 | 0.62 |
| Comparative Example 3 | 24.0 | 0.9 | 1.0 |

Referring to Table 2, it was confirmed that pure black color was realized in Examples 1 to 3 in which the printed layer was formed because L*, a*, b* color coordinates satisfied the ranges of L*: 20.0 to 21.5, a*: 0.1 to 0.3, and b*: 0.1 to 0.4, but pure black color was not realized in Comparative Examples 1 to 3 because L* was from 22.0 to 24.0, a* was from 0.3 to 0.9, and b* was from 0.4 to 1.0.

The foregoing has illustrated and described specific embodiments. However, it should be understood by those of skilled in the art that the disclosure is not limited to the above-described embodiments, and various changes and modifications may be made without departing from the technical idea of the disclosure described in the following claims.

What is claimed is:

1. A black glass-ceramic top plate for a cooking apparatus, the black glass-ceramic top plate comprising:
a black glass-ceramic substrate including a chemically strengthened upper surface;
a shielding region provided with a printed layer under the black glass-ceramic substrate to block light transmission; and
a transmissive region not provided with the printed layer under the black glass-ceramic substrate to transmit light,
wherein the printed layer is not included in the transmissive region, and
wherein the printed layer comprises:
a background printed layer under the black glass-ceramic substrate; and
a shielding printed layer under the background printed layer.

2. The black glass-ceramic top plate according to claim 1, wherein the shielding region has a chromaticity of L*: 20.0 to 21.5, a*: 0.1 to 0.3, and b*: 0.1 to 0.4.

3. The black glass-ceramic top plate according to claim 1, wherein the transmissive region has a chromaticity of L*: 22.0 to 24.0, a*: 0.3 to 0.9, and b*: 0.4 to 1.0.

4. The black glass-ceramic top plate according to claim 1, wherein the black glass-ceramic substrate comprises lithium aluminosilicate-based crystalline glass including Li₂O, Al₂O₃, and SiO_{2.}

5. The black glass-ceramic top plate according to claim 4, wherein the black glass-ceramic substrate further comprises at least one element selected from V, Mg, P, Fe, Ti, and Zr.

6. The black glass-ceramic top plate according to claim 1, wherein the black glass-ceramic substrate comprises at least one crystal phase selected from β-quartz, β-spodumene, and β-eucryptite crystal phases.

7. The black glass-ceramic top plate according to claim 1, wherein the upper surface of the black glass-ceramic substrate is chemically strengthened by ion exchange with a strengthening salt of KNO₃.

8. The black glass-ceramic top plate according to claim 1, wherein a chemical strengthening depth is from 350 nm to 5.7 μm from the upper surface.

9. The black glass-ceramic top plate according to claim 1, wherein a Vickers hardness of the black glass-ceramic top plate is from 950 to 1,300 Hv.

10. The black glass-ceramic top plate according to claim 1, wherein a falling ball breakage rate of the black glass-ceramic top plate is 10% or less in a case of dropping a 535 g-steel ball from a height of 60 cm over the black glass-ceramic top plate.

11. An induction heating device comprising:
a cooking apparatus top plate on which cooking vessels are placed; and
a plurality of induction heating coils under the cooking apparatus top plate and configured to generate a magnetic field,
wherein the cooking apparatus top plate comprises:
a black glass-ceramic substrate including a chemically strengthened upper surface;
a shielding region provided with a printed layer under the black glass-ceramic substrate;
a transmissive region to transmit light, wherein the printed layer is not included in the transmissive region; and
a light-emitting diode (LED) display under the transmissive region.

12. The induction heating device according to claim 11, wherein the printed layer comprises:
a background printed layer under the black glass-ceramic substrate; and
a shielding printed layer under the background printed layer.

13. The induction heating device according to claim 11, wherein the shielding region has a chromaticity of L*: 20.0 to 21.5, a*: 0.1 to 0.3, and b*: 0.1 to 0.4, and
the transmissive region has a chromaticity of L*: 22.0 to 24.0, a*: 0.3 to 0.9, and b*: 0.4 to 1.0.

14. The induction heating device according to claim 11, wherein the black glass-ceramic substrate comprises lithium aluminosilicate-based crystalline glass including Li₂O, Al₂O₃, and SiO_{2.}

15. The induction heating device according to claim 14, wherein the black glass-ceramic substrate further comprises at least one element selected from V, Mg, P, Fe, Ti, and Zr.

16. The induction heating device according to claim 11, wherein the black glass-ceramic substrate comprises at least one crystal phase selected from β-quartz, β-spodumene, and β-eucryptite crystal phases.
